(19) United States
(12) Patent Application Publication
(10) Pub. No.: US 2006/0019508 A1
(43) Pub. Date: Jan. 26, 2006

(54) Terminal formation for socket employed on CPU

(75) Inventor: Jui-Hsiang Lin, Taipei (TW)

Correspondence Address: TROXELL LAW OFFICE PLLC, Suite 1404, 5205 Leesburg Pike, Falls Church, VA, 22041, US

(73) Assignee: Ronmee Industrial Corporation

(21) Appl. No.: 10/846,524

(22) Filed: May 17, 2004

(30) Foreign Application Priority Data
Apr. 27, 2004 (TW) 93206438

(51) Int. Cl. H01R 12/00

(52) U.S. Cl. 439/66

(57) ABSTRACT

A terminal formation method for the socket especially employed on the CPU. The terminal is integrally pressed in the form of a plane surface with one end the terminal body extended to form the first contact and the central part of the terminal body extended to be the second contact, these two contacts stand just like a capitalized alphabet B but not connected in the center. The first contact and the second contact are bent in the opposite direction and maintaining good elasticity. Because it is integrally formed in a plane surface by one pressing operation, no further processing of bending and soldering is required. This simple structure is good for mass production with high quality without considering the deformation in the future operation.

### BACKGROUND OF THE INVENTION

1. Field of the Invention

This invention relates to a terminal formation for the socket especially employed on the CPU, in particular, the terminal is formed in the plane surface by one pressing operation, requiring further process of bending and soldering. A fast stable production and uniform quality can be secured and the worry of deformation is therefore eliminated.

2. Description of the Related Art

FIG. 1 shows the prior art of terminal used in the inner connector in which the terminal 6 is fixed on the retaining plate 61 with an arm 62 is extended from the center part of the retaining plate 61 to form a “U” form having a conductor 621 at one end and a contact 622 at the bottom end and exposed out of the insulation of the connector.

After the chip module is mounted to the connector, the conductor 621 and the contact 622 of the terminal 6 will link to the conductive body and conductive plate on the PCB respectively. Because the arm 62 of the terminal 6 is under constant compression of the chip module and the PCB, an elastic deformation is taking place. Once the elasticity of the arm 62 becomes stable, the conductor 621 and the contact 622 will keep a good contact and conductivity with the chip module and PCB.

However, once the conductor 621 of the long arm 62 makes the contact to the chip module and the PCB, the electrical current will flow from the chip module to the long arm. The L route the current has to travel from the chip module to the long arm and the PCB is long way. In the electricity, the longer the current travels, more impedance will generate. Impedance means heat, in the high frequency chip module, high impedance built up signifies lot of heat generated. In case the performance of the heat sink on the chip module is poor, the consequence is the element is burnt, service span is shortened and the circuit operation is interrupted.

In general, the terminal is usually press-formed, entailing soldering and bending aftermath. In the production process, bending is always leading to angular error due to the material quality and temperature influence; as a result, the quality of such terminal is poor.

### SUMMARY OF THE INVENTION

The main object of this invention is to provide a terminal integrally formed in one pressing operation. It has a plane surface. The pressing operation is very simple, suitable for mass production with stable controllable quality and no deformation occurred in the future operation. It possesses high value for the terminal industry.

Another object of this invention is to provide a plane surface terminal for the socket used on the CPU. The terminal has two contacts bent into the “B” form so as to maintain adequate elastic contact.

### BRIEF DESCRIPTION OF THE DRAWINGS

FIG. 1 shows the prior art of the terminal.

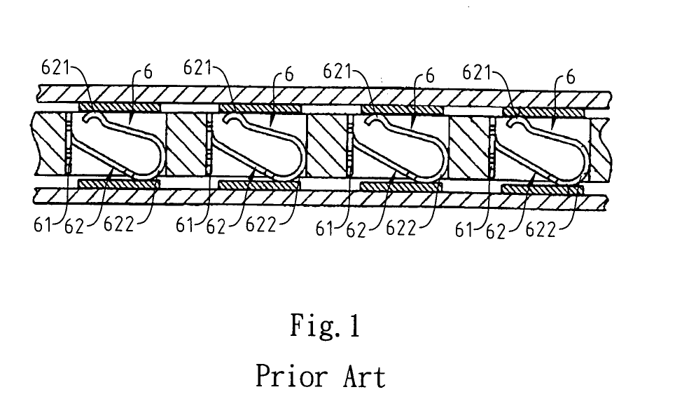

FIG. 2 shows the solid appearance of the terminal of this invention.

FIG. 3 shows the solid of the terminal is attached with the solder.

FIG. 4 shows the terminal of this invention is placed in the socket of the CPU.

FIG. 5 shows the connection of the terminal of this invention to the chip module and the PCB.

### DETAILED DESCRIPTION OF THE INVENTION

The features and characteristics are explained in great detail with the aid of preferable embodiments as illustrated in the drawings attached.

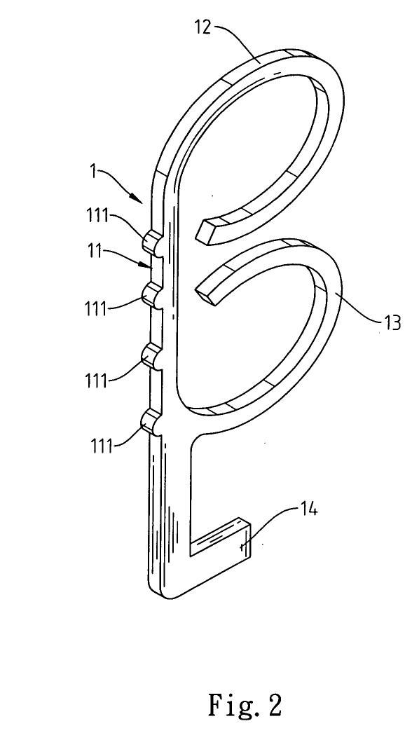

As shown in FIG. 2, the terminal 1 for the socket used on the CPU as provided in this invention is integrally formed in one pressing operation, requiring no further process of bending and soldering. It renders no angular error, least deformation, stable quality and fast production.

The terminal 1 mainly consists of the body 11, the first contact 12, the second contact 13 and the soldering leg 14. The terminal 1 links to the first contact 12, the second contact 13 and the soldering leg 14 by means of the body 11.

One end of the body 11 extends to form the first contact 12 and the center part extends to form the second contact 13. Both contacts 12, 13 are bent symmetrically in the opposite position and maintain adequate elasticity.

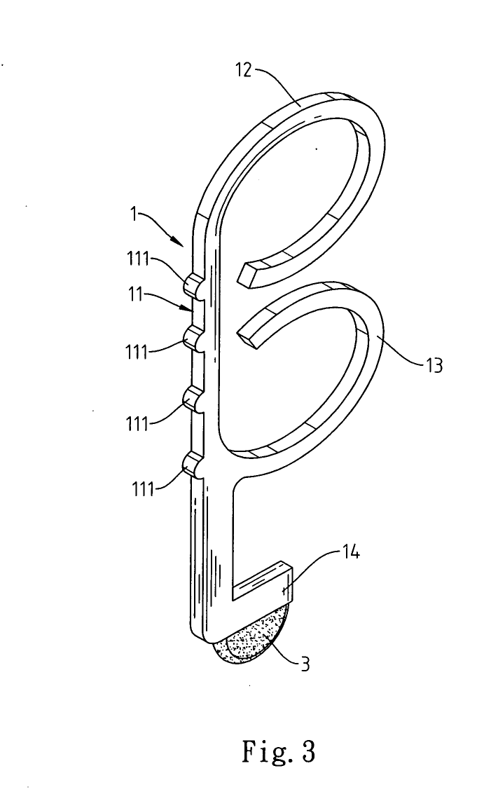

Now pleas refer to FIGS. 2 and 3, this terminal 1 is press-formed and the soldering leg 14 is attached with a heat solder 3, due to the forces of internal adduction and shrinkage, the solder 3 becomes a semicircle attached to the end of the soldering leg 14.

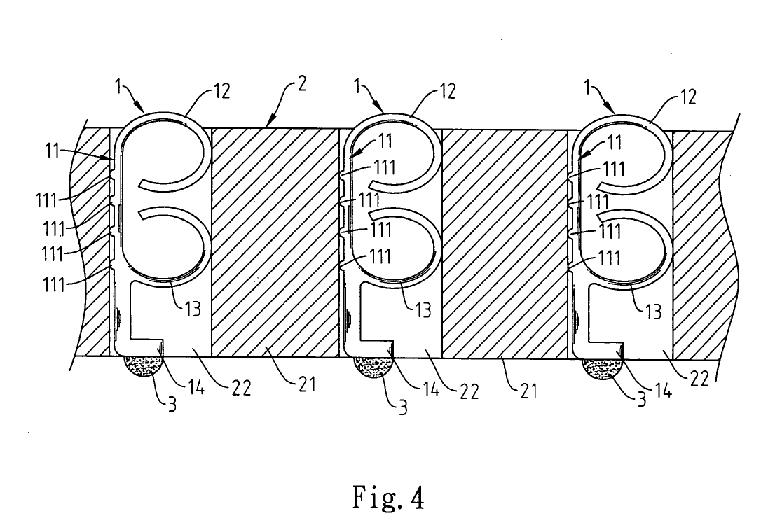

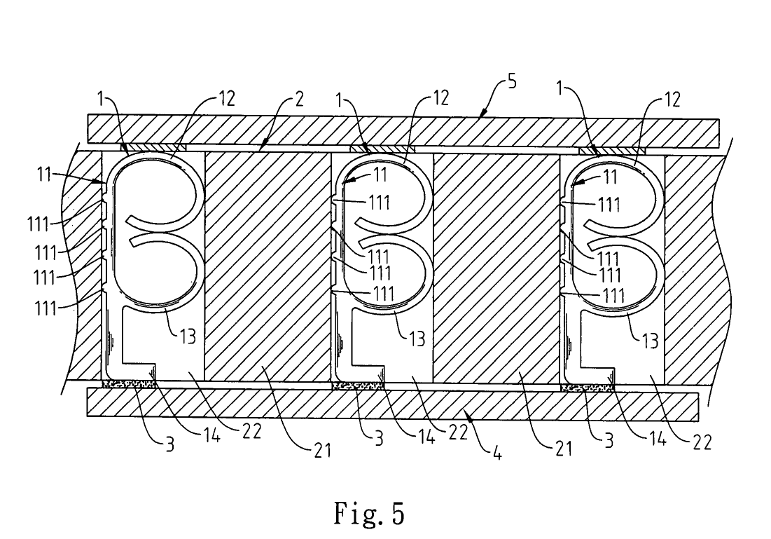

As shown in FIGS. 4 and 5, the terminal 1 is placed in the slot 22 of the insulation 21 of the connector 2 and the catch ear 111 on the terminal body 11 is caught on the inner wall of the slot 22. After the terminal 1 is fixed in place, the first contact 12 will partially pop out of the top of the slot 22 and the solder leg 14 is flush with the rim of the slot mouth 22, but the solder 2 extends out of the slot 22. The terminal 1 will be soldered to the PCB 4 when the solder 2 are heated and bind to the PCB.

The terminal 1 has the first contact 12 and the second contact 13. The second contact 13 is capable to effective dissipate the heat or disperse the compression the chip 5 applies to the first contact 12 which will never be deformed or damage due to the compression applied by chip 5.

The above statement pertaining to the novel terminal integrally formed for the socket used on the CPU is justified for the grant of a patent. Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What the invention claimed is:

1. A terminal formation for the socket employed on CPU where the terminal is plane surface structure, integrally press-formed; the body extends one end to form the first contact and the center extends to be the second contact; said two contacts form a “B” shape but not linked together; two contacts are bent symmetrically in opposite position and maintain adequate elasticity.
